(19) United States
(12) Patent Application Publication
(10) Pub. No.: US 2004/0140806 A1
(43) Pub. Date: Jul. 22, 2004

(54) Magnetic resonance tomography device with adhesive bonding forming a predetermined breaking point

(76) Inventors: Johann Schuster, Oberasbach (DE); Stefan Stocker, Erlangen (DE)

Correspondence Address: SCHIFF HARDIN, LLP, PATENT DEPARTMENT, 6600 SEARS TOWER, CHICAGO, IL, 60606-6473, US

(21) Appl. No.: 10/684,908

(22) Filed: Oct. 14, 2003

(30) Foreign Application Priority Data
Oct. 17, 2002 (DE) 10248499.6

(51) Int. Cl. G01V 3/00

(52) U.S. Cl. 324/318

(57) ABSTRACT

A magnetic resonance tomography apparatus has various components that are connected by being firmly bonded with adhesive bonding. Nondestructive detachable adhesive bonding is achieved by the adhesive bonding having at least one separation layer.

### BACKGROUND OF THE INVENTION

1. Field of the Invention

The present invention in general concerns magnetic resonance tomography (MRT) as it is employed in medicine for examination of patients. The present invention in particular concerns a magnetic resonance tomography device in which device components that are to be firmly connected are adhered via a nondestructive, detachable component bonding.

2. Description of the Prior Art

MRT is based on the physical phenomenon of nuclear magnetic resonance and has been successfully used as an imaging method for over 15 years in medicine and biophysics. In these examination methods, the subject is exposed to a strong, constant magnetic field. The nuclear spins of the atoms in the subject, which previously were randomly oriented, are thereby aligned. Radio-frequency energy can now excite these “ordered” nuclear spins to a specific oscillation. This oscillation generates the actual measurement signal, which is acquired by suitable receiver coils. By the use of non-homogenous magnetic fields generated by gradient coils, the measurement subject can thereby be spatially coded in all three spatial directions. The method enables a free selection of the layer to be imaged, so that cross-sections (slices) of the human body can be acquired in all directions. The MRT as a tomographic method in medical diagnostics is distinguished primarily as a ‘non-invasive’ examination method with versatile contrast. Due to the excellent presentation of the soft tissue, MRT has developed into a method in many cases superior to x-ray compute tomography (CT). MRT today is based on the application of spin echo and gradient echo sequences that enable an excellent image quality with measurement times in the range of seconds to minutes.

The constant technical development of the components of MRT devices and the advent of faster imaging sequences opens MRT to ever more fields of application in medicine. Real-time imaging for the support of minimally invasive surgery, functional imaging in neurology and perfusion measurement in cardiology are only a few examples.

The basic assembly of one of the central components of such an MRT apparatus is shown in FIG. 1. FIG. 1 shows a superconducting basic field magnet 1 (for example, an axial superconducting air-coil magnet with active stray field shielding) that generates a homogenous magnetic base field in an internal space 9. The superconducting basic field magnet 1 uses coils in its wall surrounding the internal space 9 that are contained in liquid helium. The wall of the basic field magnet is a two-shell hollow cylinder that is normally composed of stainless steel. The inner shell that contains the fluid helium and also serves in part as a winding body for the magnet coils is suspended by weakly thermally-conducting glass-fiber reinforced synthetic rods (rods) on the outer shell, which is at room temperature. Between the inner and outer shells there is vacuum. The inner and outer shells are designated as a magnetic vessel.

A cylindrical gradient coil 2 is concentrically mounted in the internal space 9 of the basic field magnet 1 and is firmly connected in this space 9 by a gap-filling component bonding. Both surfaces of the gradient coil are provided with optical facing.

The gradient coil 2 is also assembled in a very complex manner: it has three sub-coils that generate gradient fields proportional to the applied current and respectively spatially perpendicular to one another, by means of which the measurement region is spatially coded. Each of these coils is provided with its own power supply in order to generate independent current pulses with precise amplitude and timing, corresponding to the sequence programmed in the pulse sequence control. The necessary currents are in the range of approximately 250 A, which result in an extraordinary heat generation in the operating state.

In order to dissipate this heat, an active cooling system is integrated into the gradient coil 2 and encapsulated with the sub-coils that generate the magnetic gradient field.

A radio-frequency coil (RF resonator or antenna, not shown in FIG. 1) is typically located inside the gradient coil 2. It has the task of converting the RF pulse emitted by a power transmitter into an electromagnetic alternating field to excite the atomic nuclei, and subsequently to transduce the alternating field originating from the precessing nuclear moment into a voltage supplied to the reception branch. The radio-frequency coil also usually is bonded with the gradient coil 2.

The components specified (basic field magnet, gradient coil, radio-frequency resonator) are the most important components of an MRT apparatus and are also very prone to interference, due to their complexity. If, for example, the gradient coil fails, it must be separated from the basic field magnet and replaced or repaired. Since the components cited above are bonded with one another, a non-destructive separation, given such conventional bonding, proves to be very difficult or complicated.

Conventionally, a separation of the component bonding ensues by thermal softening or destruction of the adhesive. In order to be able to reapply and use the corresponding component, the adhesive residues are mechanically and/or chemically removed. In particular, given the use of gap-filling adhesives, in which large quantities of adhesive material or sealing compound are used, the cleaning of the adhesive surfaces proves to be very difficult.

### SUMMARY OF THE INVENTION

An object of the present invention is to provide a magnetic resource apparatus with bonded components wherein an adhesive bonding is used that enables subsequent nondestructive separation and minimizes the effort to prepare the separated components for a new bonding.

This object is achieved according to the invention in a magnetic resonance tomography apparatus having various components that are bonded with one another by an adhesive bonding, wherein adhesive bonding has at least one separation layer.

In an embodiment of the invention, the separation layer is arranged on one of the two surfaces of the adhesive bonding.

In a further embodiment, the separation layer is (or the two separation layers are) integrated into the adhesive bonding.

The separation layer is formed of one or more adhesive bands, or from one or more self-adhesive films, or of a resin-soaked (resin-impregnated) laminate.

In order to produce the separation layer on both sides between the components, a separation layer inventively has one or more positive-fit connection sections.

The device components bonded by the adhesive bonding can be the basic field magnet and a gradient coil and/or a gradient coil and a radio-frequency resonator.

### DESCRIPTION OF THE DRAWINGS

FIG. 1 is a schematic section through the basic field magnet and the gradient coil in the internal space enclosed thereby, of a magnetic resonance tomography apparatus.

FIG. 2a schematically shows a section of a first inventive embodiment of the adhesive bonding between the basic field magnet and the gradient coil.

FIG. 2b schematically shows a section of a second inventive embodiment of the component adhesive bonding between the basic field magnet and the gradient coil.

### DESCRIPTION OF THE PREFERRED EMBODIMENTS

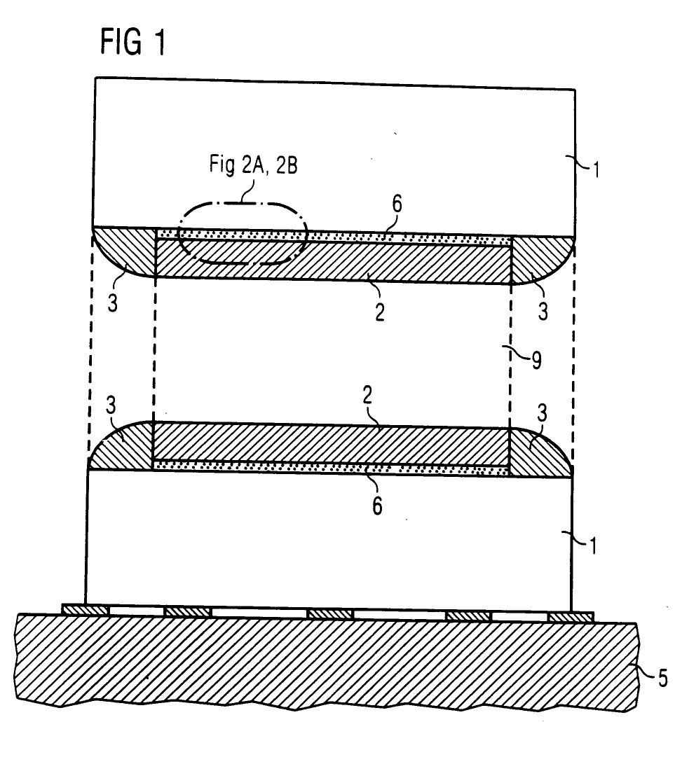

As mentioned above, FIG. 1 shows a schematic section through the basic field magnet 1 of an MRT apparatus. The gradient coil 2 is enclosed in the internal space 9 thereof. Additionally, FIG. 1 shows examples of some covering parts 3 that serve as optical facing, as well as the floor 5 upon which the MRT device stands. The present invention is concerned with the adhesive bonding, that in the case of FIG. 1 is between the basic field magnet 1 and the gradient coil 2.

As mentioned above, it is sometimes necessary to nondestructively separate components of an MRT apparatus that are bonded with one another. In current separation methods, the connecting adhesive layer is sawed away and the remaining adhesive residues of each component are removed in a relatively complicated procedure.

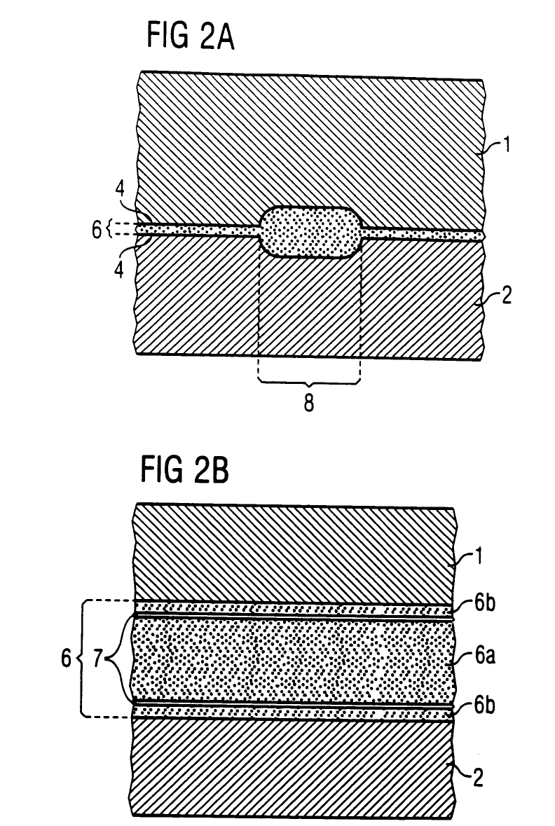

The removal of the adhesive residues can be substantially simplified by the use of an inventive adhesive layer, as shown in FIGS. 2a and 2b.

According to a first embodiment of the present invention, in FIG. 2a a component adhesive bonding 6 is shown (here, for example, between the basic field magnet 1 and the cylindrical gradient coil 2) that is composed of a filling compound (for example epoxy resin) and that has a separation layer 4 on its surfaces bordering the device components 1, 2 to be bonded. In order to remove the internal device components (for example the gradient coil 2) from the external device components (for example the basic field magnet) enclosing them, the filling compound of the component adhesive bonding 6 between the inventive separation layers is chemically, thermally, or mechanically (for example by sawing) destroyed.

The separation layers 4 effectively represent a predetermined breaking point that allow a simple removal of the filling compound residues after the release or disassembly of the part to be separated. A time-consuming cleaning of both surfaces therefore is not needed. The danger of damage or destruction of the expensive components to be separated is minimized during the adhesive residue removal by means of the inventive separation layers. The component is already prepared for a new installation immediately after the removal of the filling compound residue. The gradient coil 2 can be re-installed or a replacement gradient coil 2 can be newly installed into the basic field magnet 1.

The inventive separation layer 4 can be differently fashioned, for example as adhesive bands or self-adhesive films or a coating allowing separation of the component surfaces to be bonded.

The use of such materials as a separation layer, however, reduces the cohesion of the component connection. Therefore, to compensate this a further aspect of the present invention is to achieve a stable bonding of the components. This is accomplished by the components to be bonded and the surfaces to be bonded being fashioned such that a positive-fit connection 8 is produced between both components. In this manner, the cohesion of the connection is not defined solely by the surface adhesion between separation layer 4 and the filling material of the component adhesive bonding 6, or component surface 1, 2, but also by the mechanical properties of the filling material or the component materials. Such a positive-fit connection 8 is shown in FIG. 2a in the middle of the depicted component adhesive bonding 6. In this manner, a compact bonding to the components 1, 2 is achieved in the hardened or cured state of the filling compound of the component adhesive bonding 6.

In a second embodiment of the present invention, in FIG. 2b a component adhesive bonding 6 is shown (here again between basic field magnet 1 and cylindrical gradient coil 2) that in this case is fashioned as multiple layers. In this case, both separation layers 7 are integrated into the filling compound such as, for example, epoxy resin, also indicated in the following as the adhesive layer. The assembly in layers has the following form:

first component 1,

component-side adhesive layer 6a,

first separation layer 7,

middle adhesive layer 6a,

second separation layer 7,

component-side adhesive layer 6b,

second component 2.

The separation layers 7 can again by fashioned from adhesive bands, self-adhesive films, separation means, or even from synthetic resin (for example HGW 2372) with fiberglass cloth. A positive-fit connection is also possible in this embodiment, however it is not shown.

If, for example, the gradient coil is to be exchanged (requiring the adhesive to be removed and the gradient coil prepared for re-installation), the middle adhesive gap, for example, can be mechanically cut through between the separation layers 7, and the gradient coil 2 thus can be dismantled. The adhesive residues of the middle adhesive layers 6a can be easily removed due to the installed separation layers. Given the use of fiberglass cloth as a separation layer material, for example, its property to separate along the cloth bond can be used. The cloth bond leads to a stiffening and an increase in rigidity of the adhesive in the fiber direction. Nevertheless, a rip can easily be implemented along the cloth fibers, so the residue adhesive compound can be separated from the component-side adhesive layers 6b along the laminated fabric. Given new bonding, the bond again optimally bonds with the laminated adhesive residue 7 or 6a.

The advantages of the inventive procedure to combine the positive-fit adhesive layer with separation layers as a predetermined breaking point can be summarized as follows:

nondestructively detachable and therefore re-attachable adhesive bonding

large saving of time, since a mechanically and/or chemically elaborate removal of adhesive residues or, respectively, the preparation of the surfaces do not apply

environmentally sound preparation of the surfaces, since no aggressive solvents are necessary

minimized risk of damage to the components upon removal of the adhesive bonding or, respectively, upon removal of the adhesive residues.

Although modifications and changes may be suggested by those skilled in the art, it is the intention of the inventors to embody within the patent warranted hereon all changes and modifications as reasonably and properly come within the scope of their contribution to the art.

We claim as our invention:

1. A magnetic resonance tomography apparatus comprising:
a plurality of apparatus components; and
an adhesive bonding disposed between at least two of said apparatus components for bonding said at least of two said apparatus to each other, said adhesive bonding comprising at least one separation layer forming a predetermined breaking point for removal of at least a part of said bonding.

2. A magnetic resonance tomography apparatus as claimed in claim 1 wherein said adhesive bonding has two surfaces respectively adjacent said at least two components, and wherein said separation layer is arranged on at least one of said two surfaces.

3. A magnetic resonance tomography apparatus as claimed in claim 2 comprising respective separation layers on each of said two surfaces.

4. A magnetic resonance tomography apparatus as claimed in claim 1 wherein said separation layer is comprised of at least one adhesive band.

5. A magnetic resonance tomography apparatus as claimed in claim 1 wherein said separation layer comprises at least one self-adhesive film.

6. A magnetic resonance tomography apparatus as claimed in claim 1 wherein said separation layer comprises a resin-soaked laminate.

7. A magnetic resonance tomography apparatus as claimed in claim 1 wherein said separation layers comprises at least one positive-fit connection section making a mechanical positive-fit connection with one of said at least two components adjacent thereto.

8. A magnetic resonance tomography apparatus as claimed in claim 1 wherein said at least two components comprise a basic field magnet and a gradient coil.

9. A magnetic resonance tomography apparatus as claimed in claim 1 wherein said at least two components comprise a gradient coil and a radio-frequency resonator.
